(19) United States
(12) Patent Application Publication
(10) Pub. No.: US 2012/0075859 A1
(43) Pub. Date: Mar. 29, 2012

(54) Thermally managed, high output light-emitting-diode assembly for illumination with ease of retrofitting

(75) Inventors: Randy Martin Granado, Saratoga, CA (US); Wayne Leland Boyd, San Jose, CA (US)

(73) Assignee: AlterLume, San Jose, CA (US)

(21) Appl. No.: 13/317,184

(22) Filed: Oct. 12, 2011

(30) Foreign Application Priority Data
Aug. 3, 2010 (US) PCT/US2010/002151

(51) Int. Cl. F21V 29/00

(52) U.S. Cl. 362/249.02

(57) ABSTRACT

The present invention relates to LED assemblies used to replace bulbs in streetlights or similar illumination sources. The LED assemblies are self contained and comprise modules for the function and control of the LED assembly. The LED assembly can include additional capability for sensors and for communication external to the LED assembly. The LED assembly can include advanced features that can be remotely activated. The LED assembly fits within the same volume as the bulb it is replacing and therefore does not require the removal or addition of other hardware during the replacement of the bulb with the LED assembly.

### CROSS REFERENCE TO RELATED APPLICATIONS

This application claims priority to PCT application PCT/US2010/002151 filed on Aug. 3, 2010 which claims priority under 35 U.S.C. §119 (e) to U.S. provisional patent application Ser. No. 61/273,674 filed on Aug. 4, 2009, the contents of which is hereby incorporated herein by reference in its entirety for all purposes.

### FIELD OF INVENTION

This invention relates generally to the field of light fixtures for area illumination such as streetlights and similar sources of illumination. More specifically, this invention relates to light emitting diode (LED) assemblies that can be more easily retrofitted into common streetlight fixtures while providing improved performance.

### BACKGROUND OF THE INVENTION

The pursuit of increased energy efficiency is driving innovation in many industrial sectors. General illumination is one sector that is receiving considerable attention. Incandescent bulbs are commonly being replaced by compact fluorescent lamps (CFL) because of the lower power requirement, higher energy efficiency, and longer life of typical CFLs in comparison to common incandescent bulbs. Even better energy efficiency in the lighting sector may be obtainable with the replacement of incandescent and CFL bulbs with Light Emitting Diode (“LED”) assemblies. LED assemblies typically have lower power requirements, increased energy efficiency, and much longer lifetimes when compared to both incandescent and CFL bulbs.

One application in the general lighting sector relates to streetlights or similar sources of illumination (“streetlights” herein for economy of language) for relatively large areas such as streets, roadways, walkways, parking lots, arenas, athletic and business facilities, playgrounds, etc. Currently, this category is dominated by the use of high pressure sodium (HPS), low pressure sodium (LPS), metal halide, and high intensity discharge (HID) lamps. These existing lamps have a number of disadvantages including an unpopular color (or spectrum) of emitted light, the necessity for a special starting circuit, end of life power cycling that causes the bulb to flicker, and a relatively short lifetime. Improvements in the manufacturing and packing of LED assemblies have made LED assemblies competitive with the existing streetlight bulbs.

The typical LED assemblies that are being introduced to replace the lamp assemblies in streetlights require the replacement of the entire streetlight assembly or the lamp head assembly. This requires a significant amount of labor and thus significant labor cost for the retrofit, and also generates electronic waste that must be recycled or placed in a landfill. Current LED assemblies used in the retrofit of streetlights typically have large, complex thermal heat sinks to remove the heat generated by the LED light assembly. Additionally, these LED assemblies typically also include bulky electronic modules used to drive the LED light assemblies. These ancillary modules lead to the requirement to replace the entire streetlight assembly or the internal lamp head assembly. Smaller LED assemblies that may also serve to replace the bulbs in streetlights typically cannot be operated at the required power to generate the required amount of light to meet common streetlight specification requirements because they cannot remove the heat generated by the LED assembly. This excess heat and the use of unreliable supporting electronics lead to a reduction in performance, color output, and lifetime of the LED assembly.

Therefore, a need exists in the art for an LED assembly that can be used to retrofit an existing streetlight without the need to replace the entire streetlight assembly or the lamp head assembly. A need exists for an LED assembly that will directly connect to the standard connectors used in streetlights and can be used as a retrofit by simply replacing the existing bulb in the fixture. The LED assembly should be self-contained and comprise modules such as power module, control module, LED driver module, LED light assembly, refractor lens, on-board sensor network, communications module, and thermal management module. Furthermore, the LED assembly must fit within a volume similar to that of the existing bulb so that extra labor is not required to install the LED assembly as a bulb replacement.

### SUMMARY OF THE INVENTION

Accordingly and advantageously, some embodiments of the present invention provide an LED assembly that can be used to directly replace the bulb in a streetlight. In some embodiments, the LED assembly is self-contained and comprises modules such as power module, control module, LED driver module, LED light assembly, refractor lens, and thermal management module. Optionally, the LED assembly may also comprise an on-board sensor network and/or a communications module. The LED assembly can be designed to meet common streetlight specification requirements for power consumption and light intensity. In some embodiments, the light output of the LED assembly is capable of being altered to provide the desired output uniformity and illumination pattern by the use of reflectors, refractors, lenses, and other optical components. In some embodiments, the LED assembly can be used in a streetlight for the illumination of a roadway or for an analogous purpose wherein the light is projected in a downward direction toward the pavement, that is, in the direction toward the base of the streetlight for a light mounted on a vertical pole, or at an angle towards the pavement for lights integrated into a structure, mounted directly on a structure, or mounted on a wall, or pole (e.g. illumination in a tunnel or covered walkway). In some embodiments, the LED assembly can be used in a streetlight for the illumination of a street, parking lot, etc. wherein the light is projected downward in a substantially annular pattern from the major axis of the LED assembly. In these embodiments, the LED assembly can be used to replace a bulb that is mounted on top of a pole or can be used to replace a bulb that is hanging from a pendant.

These and other advantages are achieved in accordance with the present invention as described in detail below.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not to scale.

The techniques of the present invention can readily be understood by considering the following detailed description in conjunction with the accompanying drawings, in which:

FIG. 1 is a block diagram of a typical LED assembly showing the various functional modules.

FIG. 2 is an exploded perspective illustration of one embodiment of the present invention.

FIG. 3 is an illustration in perspective of one embodiment of the present invention.

FIGS. 4A and 4B are illustrations in perspective (4A) and end-on view (4B) of the power coupling housing components of one embodiment of the present invention.

FIG. 5 is an illustration in perspective of the heat sink component of one embodiment of the present invention.

FIG. 6 is an exploded view illustration of one embodiment of the present invention.

FIG. 7 is a block diagram of a typical LED assembly showing the various electronics functional modules.

FIG. 8 is an illustration of a typical intelligent streetlight network showing the various functional subsystems.

### DETAILED DESCRIPTION OF THE INVENTION

After considering the following description, those skilled in the art will clearly realize that the teachings of the invention can be readily utilized in the retrofitting of streetlights or similar sources of illumination with LED assemblies.

Streetlights are commonly used to provide light in public places such as roadways, streets, parking lots, walkways, parks, arenas, athletic and business facilities, etc. Various bulb types such as high pressure sodium (HPS), low pressure sodium (LPS), metal halide, and high intensity discharge (HID) lamps, as well as others have been commonly used. These bulbs typically utilize a standard connector configuration known as E39 (USA) or E40 (Europe). The “E” designates an Edison-type screw connection and the numbers (i.e. “39” and “40”) designate the size of the connector in millimeters. A discussion of the Edison screw connector may be found at the website (http://en.wikipedia.org/wiki/Edison_screw) which was downloaded by A. Helms, Jr. on Jul. 19, 2010 and is hereby incorporated herein by reference in its entirety and included with the Information Disclosure Statement filed herewith.

Some of the benefits that would be realized by the replacement of current streetlight bulbs with LED assemblies include lower power usage, increased energy efficiency, less cost to operate, and longer lifetimes. These benefits are driving interest in the design and development of LED assemblies that can be utilized in existing streetlight fixtures. To date, the LED assemblies that are available as retrofits for existing streetlights require that either the entire lamp head assembly be replaced or that the lamp, reflector, socket, electronics, and other pieces be removed to allow the LED assembly to be placed into the lamp housing. These operations increase the cost of the retrofit due to the increased labor required. Additionally, the hardware that is removed must be properly recycled and/or sent for disposal.

In some embodiments of the present invention, an LED assembly is provided that can be used to directly replace the bulb in an existing streetlight. The LED assembly is expected to use less power and provides light illumination that meets the specification requirements for the application. In some embodiments of the present invention, commercially available high power (generally 8-12 watt) LED packages are used. The LED assembly typically operates in the range from about 40 to about 80 watts. A high surface area, integrated heat sink is typically used to maintain the junction temperature of the LED diodes at safe levels according to the manufacturer's requirements. These operating conditions lead to an expected lifetime for the LED devices of approximately 50,000 operating hours. This lifetime is equivalent to more than 11 years of service with an average daily usage of 12 hours per day.

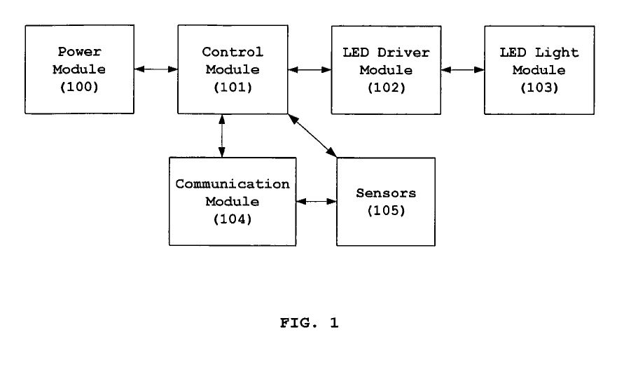

FIG. 1 is a block diagram of a typical LED assembly of the present invention showing the various functional modules. The blocks in FIG. 1 do not necessarily represent distinct physical components; they are intended to represent functional elements typically contained within the LED assembly and may be physically arranged and packaged within the assembly in any convenient manner. Power module, 100, serves as the interface between the power supplied from an external power source (not depicted in FIG. 1, typically the streetlight pole) and the LED assembly. In some embodiments of the present invention, the power module is compatible with standard sockets found in streetlights. Examples of standard sockets include, but are not limited to, cable connectors, E26, E27, E39, E40, B22-bayonet style, and plug-in style connectors.

Control module, 101, handles primary control functions within the LED assembly. Control module, 101, regulates power transfer between the power module, 100, and the LED driver module, 102. Additionally, and advantageously, some embodiments optionally include communication module, 104, that interfaces with control module 101, to control the operation of the LED assembly in response to external inputs and/or to provide information concerning the operation of the LED assembly to an external controller (human or electronic). Control module, 101, typically contains the functionality for advanced feature options such as dimming, flashing, signaling, color and illumination balance, remote monitoring, remote data collection, product identification, or remote troubleshooting etc.

Typical LED assemblies may also include one or more sensors for collecting data at various locations and about various functions, depicted schematically as 105. These sensors may provide information directly to the control module 101 as depicted in FIG. 1 and/or to the communication module 104 for delivery to the control module or to an external controller.

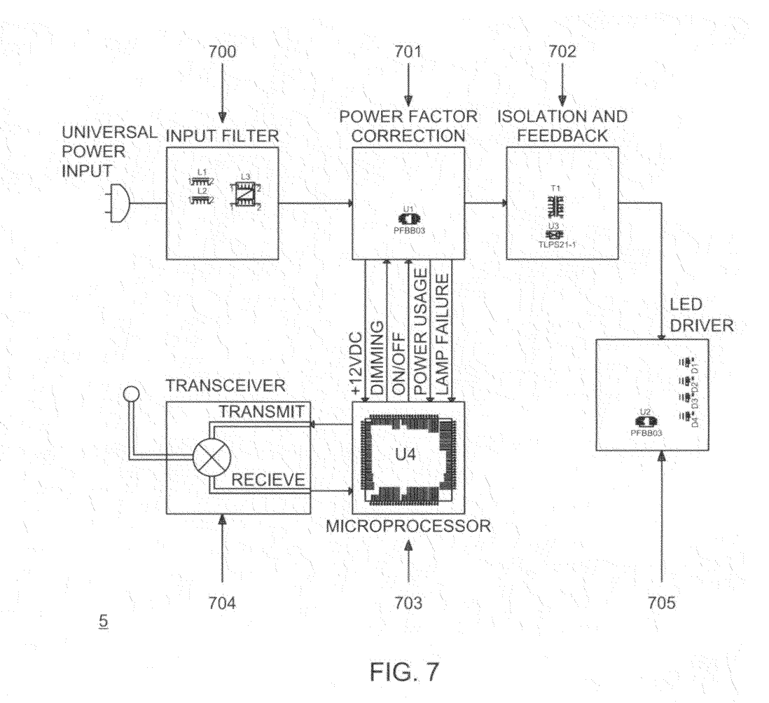

LED driver module, 102, functionally contains the circuits required to drive the LED devices. The LED driver module typically contains circuits for supplying, controlling, limiting, and conditioning the power supplied to the LED devices. LED driver module, 102, generally utilizes circuit designs so that the Power Factor Correction (PFC) of the LED assembly is greater than about 90%. One example of a suitable circuit design technique may be found in U.S. Pat. No. 7,391,630 by Acatrinci. The contents of this patent are hereby incorporated by reference for all purposes and this patent document is included with the Information Disclosure Statement filed herewith. This circuit design allows for the use of a single stage power supply which yields a 50% saving in cost and space. As described in the abstract of the Acatrinci patent:
“The system includes a bridge rectifier, boost or buck-boost converter, complex load (i.e. the LED assembly [example added]), and pulse width modulation (PWM) controller to provide pulses with variable duty cycle to a power switch. The invention is a constant pulse proportional current (CPPC) PWM controller that generates trains of pulses constant in frequency and duty cycle for one semi-cycle of the VAC. The duty cycle of the driving signal is modified by applying open-loop correction signals to summing nodes of PWM circuits. Since the PWM provides a constant train of driving pulses with constant duty cycle for one semi-cycle of the VAC, the current absorbed by the converter is contingent and linearly proportional to the voltage resulting in a power factor of near unity”.
   This circuit design provides for an active PFC method wherein a PWM is achieved that has a constant pulse, fixed frequency, and constant duty cycle for one semi-cycle of the alternating current voltage (VAC). This results in the current following the voltage. Other circuit design approaches must force the current to be sinusoidal. The use of the CPPC design or similar circuit design schemes avoids the complexities of forced sinusoidal methods, enables simple and scalable system designs, leads to systems of lower cost, yields higher system level efficiencies, and enables a single stage design. Functional subassemblies of the circuit design are illustrated in FIG. 7 and discussed below.

LED light module 103, contains one or more LED device packages (“LED packages”) not depicted in FIG. 1. Typically, high power LED packages (with power in the range of approximately 8-12 watts) are used. The high power LED packages contain one or more individual LED devices. These packages allow the generation of light with high intensity. The LED light module advantageously includes an integrated heat sink to remove the heat generated by the LED packages and maintain the junction temperature of the LED devices at safe levels according to the manufacturer's requirements. The heat sink typically employs a finned design that creates a large surface area of the heat sink while being contained within a small volume. Typically, the heat sink uses a material with a thermal conductivity of greater than about 150 W/K-m (150 Watts/(deg. Kelvin-meter)). As an example, pure aluminum has a thermal conductivity of 237 W/K-m. Aluminum alloys with a thermal conductivity greater than about 150 W/K-m are also good candidates for the heat sink material. In one embodiment of the present invention, the heat sink has a surface area of at least about 2500 square centimeters. Optionally, LED light module, 103, may additionally comprise one or more active cooling mechanisms to increase the amount of heat that can be removed by the heat sink. Examples of active cooling mechanisms include, but are not limited to, air pulse modules, liquid cooling systems, vapor chamber cooling systems, heat pipe systems, fans, electric coolers, etc.

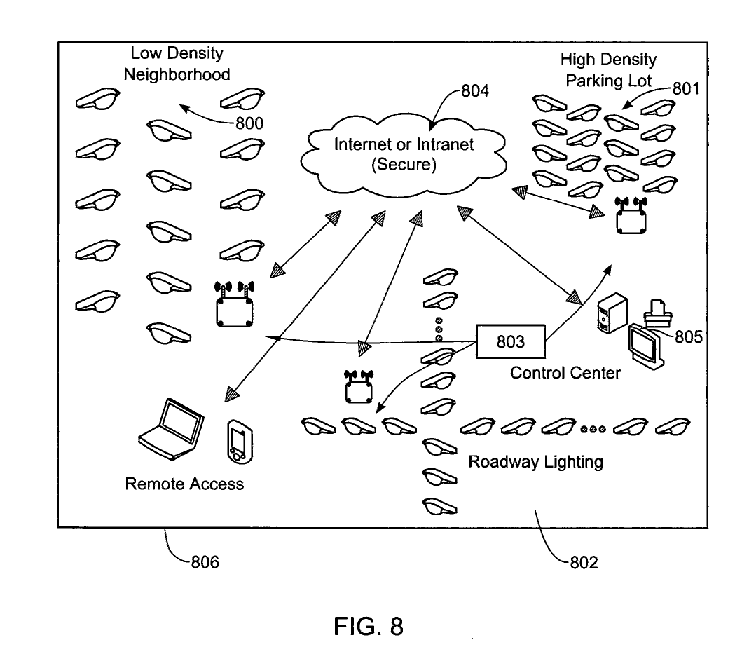

Communications module, 104, serves as the communications link from the LED assembly to an external receiver or an external network such as the Internet, a Large Area Network (LAN), a Wide Area Network (WAN), a wireless network, cellular networks (e.g. GSM, GPRS, etc.), WiFi networks, combinations thereof, and the like. The network and communications protocols will typically include the necessary security features so that only authorized persons would be able to address the communications module and the module identification can be verified. This capability allows increased functionality to be realized within the LED assembly and allows the streetlights to be configured into an intelligent network. Examples of increased functionality include operations such as dimming, flashing, signaling, color and illumination balance, remote monitoring, remote data collection, product identification, remote troubleshooting, ambient temperature sensing and reporting, pedestrian or traffic sensing and monitoring, pedestrian streetlight control, streetlight pole damage monitoring, incorporation of taxi or bus call functions, etc. These features, when present, would allow stakeholders such as Utilities, Cities, Counties, States, Federal Agencies, facility managers, etc. to monitor and actively control the streetlights to make efficient use of the lighting, minimize the power usage, identify streetlights that require service, etc. An illustration of one example of an intelligent streetlight network is shown in FIG. 8 and discussed below.

Sensor module, 105, represents one or more sensors that may be associated with the LED assembly to collect information concerning the operation of the LED assembly in order to facilitate the operation of the assembly and the operation of some of the advanced features listed previously. Examples of sensors that may be contained within the LED assembly include, but are not limited to, sensors for the measurement of power, current, voltage, ambient light intensity, LED light intensity, ambient temperature, heat sink temperature, LED package temperature, LED device temperature, the total time the LED assembly has been turned on, total power used, and optical cleanliness as determined by optical transmission, etc.

In some embodiments of the present invention, the illumination pattern of the LED assembly may be enhanced through the use of external optic systems. The Illumination Engineering Society of North America (IESNA) specifies five lighting (photometric) pattern standards for roadways in North America. Each existing streetlight has been configured to conform to one of the lighting pattern standards depending on its intended purpose. In the case where the mere replacement of an existing lamp bulb by an LED assembly would not faithfully reproduce the desired photometric standard, external optic elements such as reflectors, refractors, and lenses may be used to develop the desired pattern. These techniques are well known and are designed to fit within popular streetlight lamp head designs.

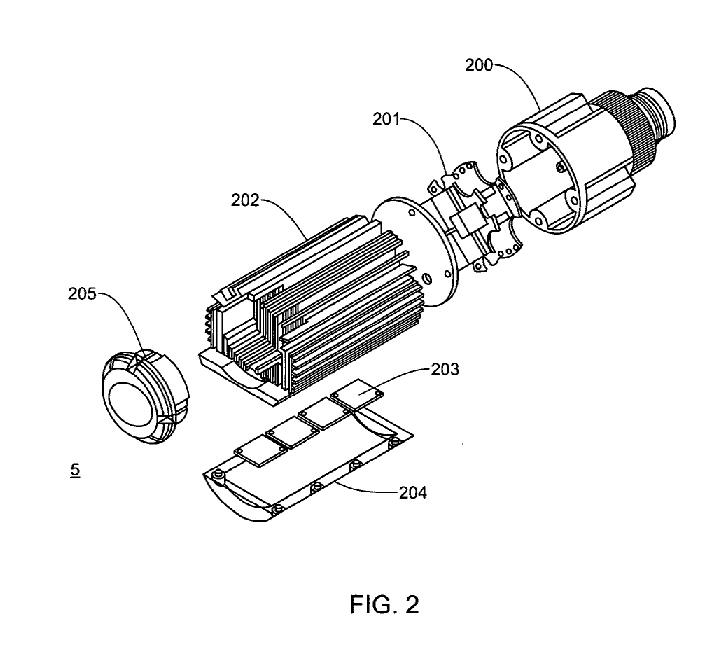

FIG. 2 is an exploded view of one embodiment of the present invention. FIG. 2 illustrates an LED assembly that may be used in a streetlight used for illumination of a roadway wherein the light is projected in a downward direction toward the pavement. This type of streetlight is commonly called a “cobra head” configuration due to the shape of the lamp housing. Power coupling housing, 200, encloses the electrical connections (not shown) involved in the connection of the LED assembly electronics package, 201, to the streetlight receptacle. Power coupling housing, 200, also encloses the LED assembly electronics package, 201. As mentioned previously, the streetlight receptacle is typically an E39 or E40 socket. Electronics package, 201, contains the control module, 101, and the LED driver module, 102. Heat sink, 202, occupies much of the volume of the LED assembly and serves to draw heat from the LED packages. The LED packages are illustrated as 203. In FIG. 2, four LED packages are shown. It will be appreciated by those skilled in the art that any number of LED packages may be used depending on the application and the illumination requirements. A first optic element, 204, is shown to collect, focus, and direct the light from the LED packages into the desired pattern. The use of an optional active cooling mechanism, 205, is illustrated in FIG. 2. Active cooling mechanism, 205, is typically an air pulse module as depicted in FIG. 2 but other cooling mechanisms can be used as would be obvious to persons having ordinary skill in the art.

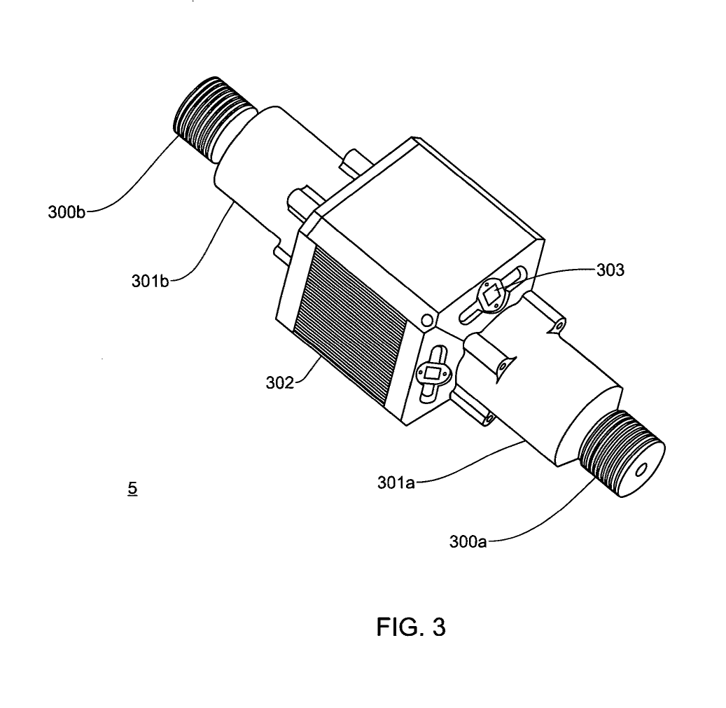

FIG. 3 is an illustration of one embodiment of the present invention. FIG. 3 illustrates an LED assembly that may be used in a streetlight used for illumination of a street or parking lot wherein the light is projected downward in an angular direction from the major axis of the LED assembly producing a pattern of illumination around the base of the pole. In this embodiment, the LED assembly may be used to replace a bulb that is mounted on top of a pole or may be used to replace a bulb that is hanging from a pendant. FIG. 3 illustrates that the LED assembly is configurable. In a first case, it is desired that an LED assembly be placed on top of a pole and illuminate an area in a downward direction around the pole. In this case, power connector, 300a, would be screwed into the socket of the lamp post. Housing, 301a, contains the power module, 100, and control module, 101. Heat sink, 302, forms the main body of the LED assembly and would also typically house the LED driver module, 102. The LED packages are illustrated as element 303. In this configuration, power connector, 300b, and housing, 301b, would not be present.

FIG. 3 is also an illustration of another embodiment of the present invention. FIG. 3 illustrates an LED assembly that may be used in a streetlight used for illumination of a street or parking lot wherein the light is projected downward in an angular direction from the major axis of the LED assembly. In this embodiment, the LED assembly may be used to replace a bulb that is mounted on top of a pole or may be used to replace a bulb that is hanging from a pendant. FIG. 3 illustrates that the LED assembly is configurable. For the embodiment described above, power connector 300a is attached to the power source on top of the mounting pole causing LED packages 303 to direct light towards and around the base of the mounting pole. In a second case, it is desired that an LED assembly hang from a pendant and illuminate an area in a downward direction. In this case, power connector, 300b, would be screwed into the socket of the pendant causing LED packages 303 to direct light towards and around the area beneath and surrounding the pendant. Housing, 301b, contains the power module, 100, and control module, 101. Heat sink, 302, forms the main body of the LED assembly and would also house the LED driver module, 102. The LED packages are illustrated as element 303. In this configuration, power connector, 300a, and housing, 301a, would not be present.

FIG. 3 depicts a single LED assembly that can be used both pole mounted and pendant mounted. However, this is by way of illustration and not limitation since different devices can readily be constructed for pole mounting (omitting 300b and 301b), and pendant mounting (omitting 300a and 301a), all included within the scope of the present invention.

In some embodiments of the present invention, the LED assembly is designed to operate consuming electrical power at levels between about 40 and about 80 watts. This power level is typically higher than LED assemblies that have been previously designed to be compatible with E39 and E40 sockets. Generally, the previous LED assembly designs compatible with E39 or E40 sockets operate at power levels of about 30 watts or less. These lower power designs are generally unable to generate the required light intensity. In some embodiments of the present invention, the LED assembly is designed to generate at least 90 lumens per watt of light intensity using high power, high brightness LED packages, the CPPC circuit design discussed previously, and a high surface area, integrated heat sink. This yields an illumination intensity of between about 3600 and about 7200 lumens for the designs pursuant to some embodiments of the present invention.

In some embodiments of the present invention, the LED assembly is designed to serve as a direct replacement for the existing bulb in a streetlight. In such cases the LED assembly comprises a power module, a control module, an LED driver module, one or more LED packages, and a heat sink all assembled with fasteners and o-ring seals. The power module is designed so that it couples to a standard streetlight connector. Therefore, the LED assembly is designed so that the power requirements, illumination intensity, and heat removal requirements can be realized within the same volume as that occupied by the existing bulb. Generally, the existing bulbs used in streetlights occupy approximately about 800 to about 1700 cubic centimeters of volume. The use of high power, high brightness LED packages, advanced electronics (i.e. CPPC circuit designs), and a high capacity heat sink allows the present invention to operate between about 40 and about 80 watts, to generate at least about 90 lumens per watt of light intensity, and to fit within a volume of about 1100 to about 2000 cubic centimeters.

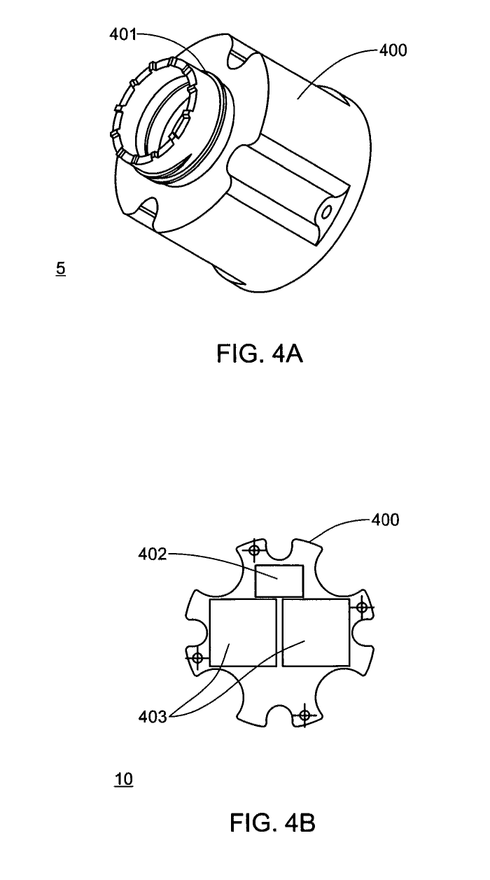

FIGS. 4A and 4B are illustrations of the power coupling housing. The main housing, 400, forms the primary structure for the circuits and electrical connections between the standard streetlight socket (not shown) and the rest of the LED assembly. The threads used to interface the LED assembly with a screw-type socket (i.e. an E26, E27, E39, or E40 type connector) are illustrated by element 401 in FIG. 4A. In FIG. 4B, the location for the rectifying circuit is illustrated at element 402 and the location for the transformers and other electronics are illustrated at elements 403.

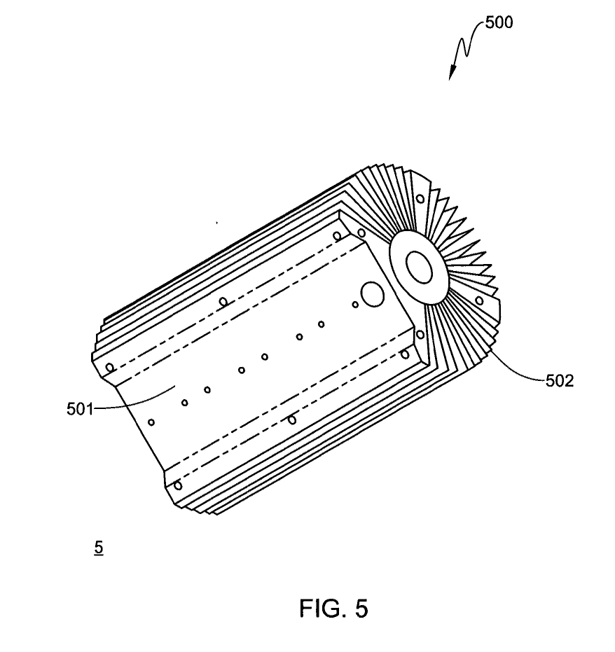

FIG. 5 is an illustration of an integrated heat sink, 500, that can be used to remove heat from the LED packages as well as the electronics package. The heat sink is formed from a material with a high thermal conductivity (i.e. greater than about 150 W/K-m). As mentioned previously, aluminum and some aluminum alloys are good examples. The LED packages are mounted along the flat surface, 501. Heat sink, 500, is passively cooled by high surface area fins, 502. Fins, 502, can be formed so that their total surface area is between about 2500 square centimeters and about 5000 square centimeters. As an example, FIG. 5 illustrates a heat sink with about 30 small fin structures. Each small fin can arrayed about the major axis of the LED assembly. The small fin structures can be vertical and perpendicular from the surface of the heat sink to which the LED packages are mounted to provide at least about 65 square centimeters of cooling surface area per watt used. This allows heat sink, 500, to remove the heat from the LED packages and maintain the junction temperature of the LED devices at safe levels according to the manufacturer's requirements. As mentioned previously, active cooling mechanisms such as air pulse modules, liquid cooling systems, vapor chamber cooling systems, heat pipe systems, fans, electric coolers, etc. may be used to enhance the heat removal capability of heat sink, 500.

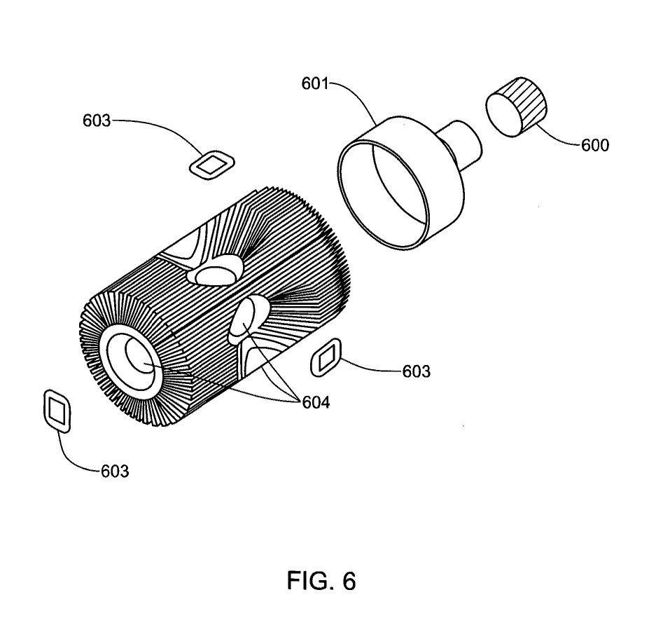

FIG. 6 is an exploded view of one embodiment of the present invention. FIG. 6 illustrates an LED assembly that may be used in an illumination application wherein the light is projected downward and in an angular direction from the axis of the LED assembly. The interface to the standard socket is illustrated by element 600. Power coupling housing, 601, forms the primary structure for the circuits and electrical connections between the standard streetlight socket (not shown) and the rest of the LED assembly. The heat sink is illustrated by element 602. In this case, the heat sink, 602, is axially symmetric and comprises cavities or pockets, 604, which hold the LED packages, 603. This type of LED assembly is best suited for applications wherein the major axis of the LED assembly is oriented vertically.

FIG. 7 is a block diagram of a typical LED assembly of the present invention showing the various electronics functional modules. The blocks in FIG. 7 do not necessarily represent distinct physical components; they are intended to represent functional elements typically contained within the LED assembly and may be physically arranged and packaged within the assembly in any convenient manner. Functional block, 700, illustrates the portion of the circuit used to filter and condition the input power. As mentioned previously, the LED assembly can connect to a variety of standard streetlight connectors. Illustrated in this block are inductors L1, L2 and transformer, L3. These components and methods of filtering and conditioning the input power are well known in the art. Functional block, 701, illustrates the portion of the circuit used to provide the power factor correction as discussed previously. The power factor correction is implemented by component U1 which is a PF8803 chip available from Power Factor 1 in Santa Clara, Calif. Those skilled in the art will realize that other chips with similar functionality can also be used. Functional block, 702, illustrates the portion of the circuit used to provide isolation and feedback functions within the LED assembly electronics. Illustrated in this block are transformer, T1, and a photocoupler, U3, which is a TLP521-1 chip from Toshiba in Japan. Those skilled in the art will realize that other chips with similar functionality can also be used. Functional block, 703, illustrates a microprocessor that serves to implement the advanced features of the LED assembly discussed earlier. A subset of the advanced features is illustrated in this block including dimming, on/off control, power usage monitoring, and lamp failure monitoring. Those skilled in the art will realize that many other of the advanced features discussed previously can be implemented by the microprocessor. Additionally, the microprocessor, 703, facilitates the communication from the LED assembly to an external network through transceiver, 704. Transceiver, 704, comprises both transmit and receive capabilities and can communicate to the external network through either wired or wireless technologies. Preferably, Transceiver, 704, communicates to the external network using a wireless technology. Functional block, 705, illustrates the portion of the circuit used to provide the driver circuit for the LED packages. The LED packages are illustrated as components, D1-D4. An additional PF8803 chip available from Power Factor 1 in Santa Clara, Calif. is also used in this portion of the circuit design and is illustrated as component U2. Those skilled in the art will realize that other chips with similar functionality can also be used.

FIG. 8 is an illustration of the configuration of the streetlights into an intelligent network showing the various function subsystems. Three possible spatial configurations of the streetlights are illustrated.

Those skilled in the art will realize that many other configurations will be possible. A first configuration consists of streetlights configured into a low density pattern that might be associated with a neighborhood. The low density pattern is illustrated by object 800. A second configuration consists of streetlights configured into a high density pattern that might be associated with a parking lot where a greater density of illumination is desired. The high density pattern is illustrated by object 801. A third configuration consists of streetlights configured into a linear pattern that might be associated with a street or roadway where the streetlight pattern follows the layout of the street or roadway. The linear pattern is illustrated by object 802. In each of the configurations listed above, the streetlights are formed into an intelligent mesh network. Each streetlight typically communicates with 2 or more neighboring streetlights. This allows the network to be self-healing if one or more streetlights fail. In each case, a number of nodes communicate with local gateways, 803, that are connected via a secure internet or intranet, 804, to a central control center, 805. Typically, up to 1000 streetlights may use a single gateway to connect to the central control center. Those skilled in the art will realize that the number of streetlights that may use a single gateway will increase in the future as wireless technology and network technology improves. The connection between the gateways and the secure Internet or intranet may be wired or may be wireless, but preferably they utilize wireless technologies.

The central control center, 805, allows the streetlight network and the individual streetlights to be controlled to add additional functionality to the streetlights. Examples of increased functionality include operations such as dimming, flashing, signaling, color and illumination balance, remote monitoring, remote data collection, product identification, remote troubleshooting, ambient temperature sensing and reporting, pedestrian or traffic sensing and monitoring, pedestrian streetlight control, streetlight pole damage monitoring, incorporation of taxi or bus call functions, etc. These features, when present, would allow stakeholders such as Utilities, Cities, Counties, States, Federal Agencies, facility managers, etc. to monitor and actively control the streetlights to make efficient use of the lighting, minimize the power usage, identify streetlights that require service, etc. Also illustrated in FIG. 8 is the opportunity to interact and control the streetlight network remotely. The remote interaction and control of the network is illustrated by object, 806. This would allow the control and operation of the streetlight network from a remote device such as a laptop computer, personal data assistant (PDA), mobile phone, or other remote device. This functionality allows control of the streetlight network from the field and does not require physical presence in the central control center.

In some embodiments of the present invention, the LED assembly is used in conjunction with advanced optical elements to give the streetlight new capabilities. Active optical elements such as an adjustable iris, moveable lenses, moveable reflectors, rotation of the bulb fixture, etc. could be controlled through the communications and control modules and would allow the illumination pattern of the streetlight to be configured from a remote location and would allow, for example, the illumination pattern to be altered to meet new application requirements.

Although various embodiments which incorporate the teachings of the present invention have been shown and described in detail herein, those skilled in the art can readily devise many other varied embodiments that still incorporate these teachings.

What is claimed is:

1. An apparatus comprising:
a. a light emitting diode assembly comprising
i. a power module (100) wherein the power module couples to a standard streetlight connector;
ii. a control module (101);
iii. a constant pulse proportional current light emitting diode driver module (102);
iv. one or more light emitting diode packages (203);
v. an integrated heat sink (202);
b. wherein the light emitting diode assembly operates at a power of between 40 and 80 watts and generates at least 90 lumens per watt of light intensity; and
c. wherein the light emitting diode assembly occupies a volume of less than about 2000 cubic centimeters.

2. The apparatus of claim 1 further comprising sensors (105).

3. The apparatus of claim 2 wherein the sensors comprise one or more sensors for the measurement of one or more of the following properties of said apparatus: power, current, voltage, ambient light intensity, LED light intensity, ambient temperature, heat sink temperature, LED package temperature, LED device temperature, the total time the LED assembly has been turned on, total power used, and optical cleanliness as determined by optical transmission.

4. The apparatus of claim 2 further comprising a communications module (104) that serves as a communications link to a network or receiver external to the LED assembly.

5. The apparatus of claim 4 wherein the communications link to a network or receiver external to the LED assembly allows functionality for advanced feature options comprising one or more of the following: dimming, flashing, signaling, color and illumination balance, remote monitoring, remote data collection, product identification, remote troubleshooting, ambient temperature sensing and reporting, pedestrian or traffic sensing and monitoring, pedestrian streetlight control, streetlight pole damage monitoring, or incorporation of taxi or bus call functions.

6. The apparatus of claim 1 further comprising a communications module (104).

7. The apparatus of claim 1 wherein the standard streetlight connector is any one of cable connectors, E26, E27, E39, E40, bayonet style, or plug-in style connectors.

8. The apparatus of claim 1 wherein the heat sink is manufactured from a material having a thermal conductivity of greater than about 150 W/K-m.

9. The apparatus of claim 8 wherein the heat sink material is aluminum or an aluminum alloy.

10. The apparatus of claim 8 wherein the heat sink material has a surface area of at least 2500 square centimeters.

11. The apparatus of claim 8 further comprising an active cooling mechanism (205).

12. The apparatus of claim 11 wherein the active cooling mechanism comprises one or more of air pulse modules, liquid cooling systems, vapor chamber cooling systems, heat pipe systems, fans, or electric coolers.
